(19) United States
(12) Patent Application Publication
(10) Pub. No.: US 2008/0136949 A1
(43) Pub. Date: Jun. 12, 2008

(54) OPTICAL IMAGE CAPTURE STRUCTURE

(76) Inventor: Hsu-Lien HUANG, Chiayi City (TW)

Correspondence Address: RABIN & Berdo, PC, 1101 14TH STREET, NW, SUITE 500, WASHINGTON, DC, 20005, US

(21) Appl. No.: 11/749,837

(22) Filed: May 17, 2007

(30) Foreign Application Priority Data
Dec. 6, 2006 (TW) 095145520

(51) Int. Cl. G03B 13/00; G03B 3/00; H04N 3/14

(52) U.S. Cl. 348/294; 348/345; 396/89

(57) ABSTRACT

An optical image capture structure is provided, which includes a substrate, a frame, a photosensitive element, a first axial actuator, a second axial actuator, and a third axial actuator. The frame moves relative to the substrate, and the photosensitive element is mounted in the frame for capturing an optical image. The first axial actuator is connected between the frame and the photosensitive element, the second axial actuator is connected between the frame and the photosensitive element, and the third axial actuator is connected between the frame and the substrate. The first axial actuator, the second axial actuator, and the third axial actuator are used for moving the photosensitive element in a first axial direction, a second axial direction, and a third axial direction, thereby making the photosensitive element to move as an optical axis changes, thereby clearly imaging the optical image on the photosensitive element.

### CROSS-REFERENCE TO RELATED APPLICATIONS

This non-provisional application claims priority under 35 U.S.C. §119(a) on Patent Application No(s). 095145520 filed in Taiwan, R.O.C. on Dec. 6, 2006, the entire contents of which are hereby incorporated by reference.

### BACKGROUND OF THE INVENTION

1. Field of Invention

The present invention relates to an optical image capture structure, and more particularly, to an optical image capture structure for providing digital image stabilization (DIS) and quick focusing functions.

2. Related Art

As the rapid development of image transmission technology, the current portable optical image capture devices (e.g., camera phones, digital cameras, personal digital assistants (PDAs), tablet PCs, and digital video cameras) have become more and more popular, and even become prevailing among a large number of consumers as the development of the multimedia technology, and they are widely used by the common consumers as an assistant tool for recording daily images.

However, the consumer not only requires the optical image capture devices to be small in size, light in weight, and cheap, but also requires the captured object image to have a higher quality, i.e., require the captured object image frame to be clear.

The optical image capture device usually has a group of auto-focus (AF) lenses (e.g., auto-zoom lens) mounted thereon, and thus, it is capable of achieving a preferred focusing effect and a clear image when shooting objects at different distances. However, a common portable optical image capture device is generally held by the user with hand to capture the required image data, such that the image shot with the optical image capture device is easily affected by the shake of the optical image capture device due to the foot movement or vibration of the user's hands. Due to the shaking back and forth along the optical axis, the focusing is slightly changed. Although it can be adjusted by moving the lens to change the focal length, the moving rate of the whole lens or lens assembly cannot keep pace with the rate of the vibration of the hand. Moreover, the movement shifted off the optical axis will cause the image originally formed on the photosensitive element to be offset, and thereby making the image capturing result of the photosensitive element be fuzzy, and this kind of vibration offset from the optical axis cannot be compensated by changing the focusing of the lens.

Therefore, a digital image stabilization (DIS) function is usually added for the optical image capturing process to eliminate the problem of fuzzy image caused by the offset from the optical axis, but the problem in the quick autofocus (AF) still cannot be solved. Therefore, designing an optical image capture structure having both a digital image stabilization function and a focusing function is an urgent issue to be solved.

### SUMMARY OF THE INVENTION

The digital image stabilization (DIS) function of the conventional optical image capture structure only aims at eliminating the fuzzy image caused by the offset of the optical axis, but cannot adjust the focusing instantly. In view of the above problem, the present invention is directed to an optical image capture structure having both a digital image stabilization (DIS) function and a zooming function, which solves the problem of the fuzzy image caused by the vibration in different directions when being used by a user.

In order to achieve the above object, the present invention discloses an optical image capture structure, which comprises a substrate, a frame, a photosensitive element, a first axial actuator, a second axial actuator, and a third axial actuator. The frame moves relative to the substrate, and the photosensitive element is mounted within the frame for capturing an optical image. The first axial actuator is connected between the frame and the photosensitive element, for moving the photosensitive element in a first axial direction. The second axial actuator is connected between the frame and the photosensitive element, for moving the photosensitive element in a second axial direction. The third axial actuator is connected between the frame and the substrate, for moving the photosensitive element in a third axial direction. The frame moves the photosensitive element in the first axial direction, the second axial direction, and the third axial direction through the first axial actuator, the second axial actuator, and the third axial actuator, and thereby making the photosensitive element move as an optical axis changes, so as to clearly image an optical image, which is formed through optical focusing, on the photosensitive element.

The effect of the present invention lies in that, the optical image capture structure of the present invention has both a digital image stabilization (DIS) function and a simple focusing function. Moreover, three axial actuators perpendicular to each other are utilized to compensate the vibrations in each direction in the space, and a technique of driving a piezoelectric material is also utilized to achieve an instant and complete digital image stabilization (DIS) effect. Moreover, the piezoelectric material in the third axial direction is driven at the same time for achieving the digital image stabilization (DIS) and focusing functions. Therefore, the present invention effectively enhances the image-shooting quality and image-shooting function of a common simple and chic optical image capture device.

The above description of the content of the present invention and the following detailed description of the present invention are intended to demonstrate and explain the principle of the present invention, and provide a further explanation of the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a side stereogram of a preferred implementing aspect of an optical image capture structure according to the present invention;

FIG. 2A is a system schematic view of the optical image capture structure of the present invention to be operated in the first and second axial directions;

FIG. 2B is a system schematic view of the optical image capture structure of the present invention to be operated in the third axial direction;

FIGS. 3A and 3B are schematic views of the operations according to a first embodiment of the present invention;

FIGS. 4A and 4B are schematic views of the operations according to a second embodiment of the present invention; and

FIGS. 5A and 5B are schematic views of the focusing function operations of the optical image capture structure of the present invention.

### DETAILED DESCRIPTION OF THE INVENTION

In order to make the objectives, features, and advantages of the present invention be more comprehensible, embodiments accompanied with figures are described in detail below.

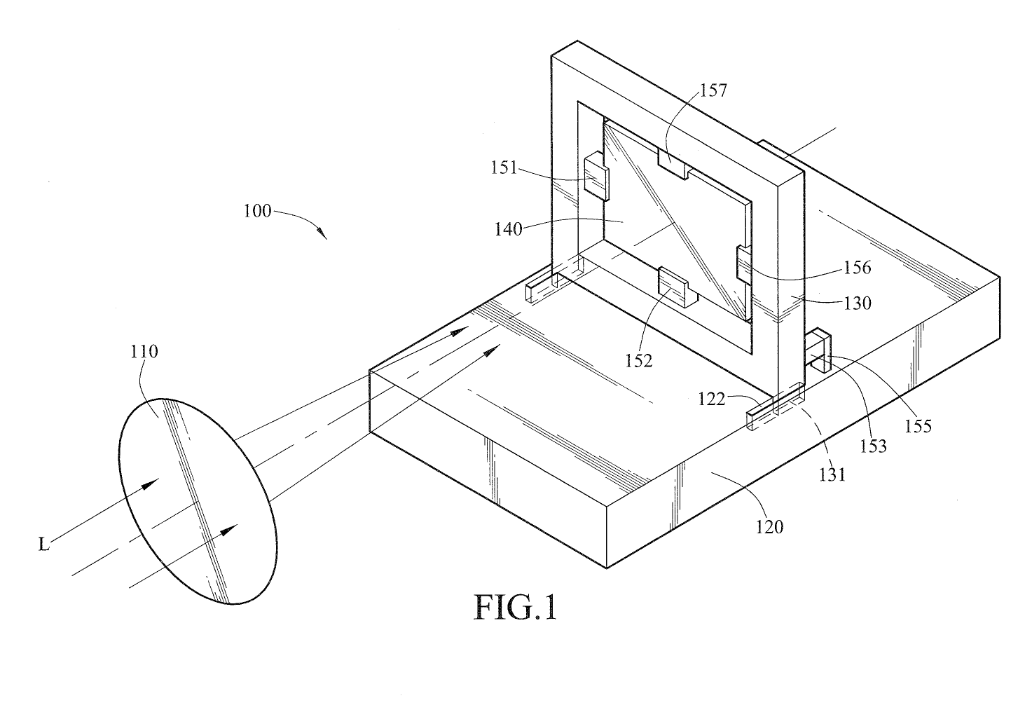

First of all, FIG. 1 is a side stereogram of a preferred implementing aspect of an optical image capture structure according to the present invention. The optical image capture structure 100 of the present invention has a lens assembly 110, a substrate 120, a frame 130, a photosensitive element 140, a first axial actuator 151, a second axial actuator 152, and a third axial actuator 153.

The lens assembly 110 includes at least one convex lens for imaging an incident light L at a predetermined position. The substrate 120 is located at a distance away from the lens assembly 110, and two opposite side edges of the substrate 120 are respectively formed with a chute 122 and a fixing member 155. The frame 130 is vertically disposed on the substrate 120, and two sides of the frame 130 are respectively formed with an embedded portion 131 for being embedded into the chute 122 of the substrate 120, and thus, the frame 130 is moved relative to the substrate 120. The photosensitive element 140 is disposed in the frame 130 by the first axial actuator 151 and the second axial actuator 152, and it is parallel to the lens assembly 110 for receiving incident lights gathered by the lens assembly 110, thereby forming an image. The photosensitive element 140 is a charge-coupled device (CCD) or a complementary metal-oxide semiconductor (CMOS).

Referring to FIG. 1, the first axial actuator 151 is connected between the frame 130 and the photosensitive element 140, for fixing the photosensitive element 140 and moving the photosensitive element 140 in a first axial direction. The second axial actuator 152 is also connected between the frame 130 and the photosensitive element 140, and located adjacent to the other side edge of the photosensitive element 140, which is also used for fixing photosensitive element 140 and moving the photosensitive element 140 in a second axial direction. The third axial actuator 153 is connected between the fixing member 155 of the substrate 120 and the frame, for moving the photosensitive element 140 in a third axial direction. Any two of the above-mentioned first, second, and third axial directions are vertical to each other.

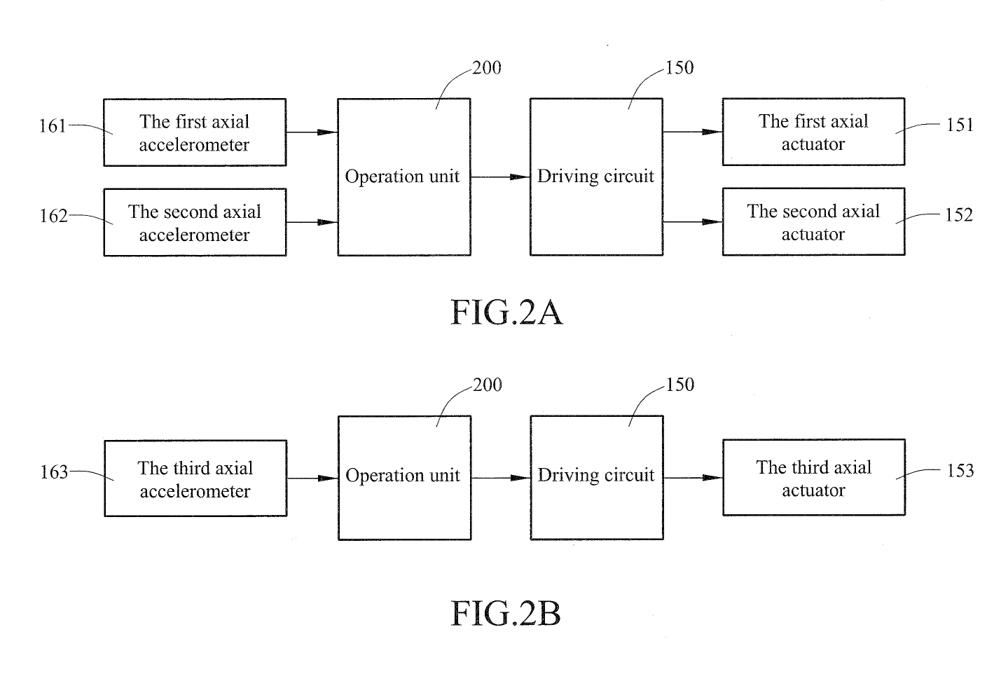

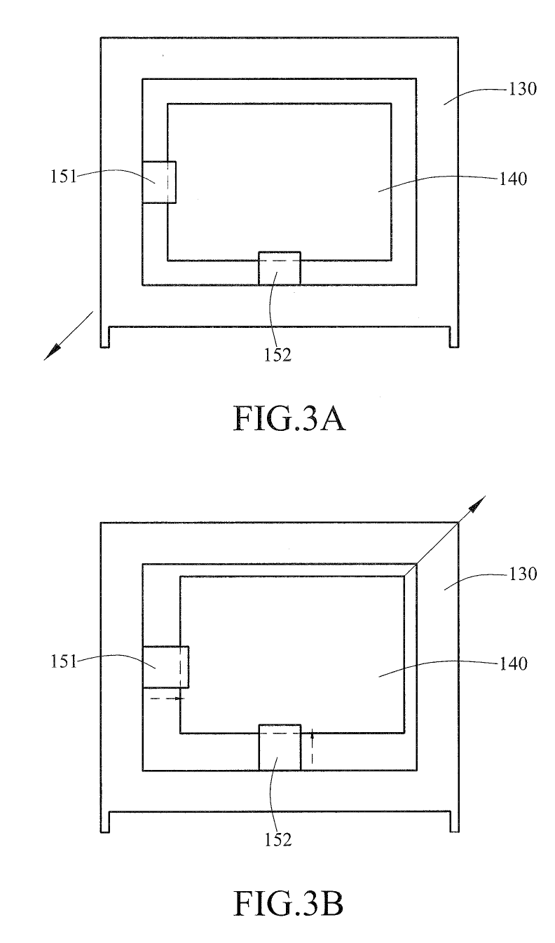

Then, FIG. 2A is a system schematic view of the optical image capture structure of the present invention to be operated in the first and second axial directions. Referring to FIG. 2A, the system for the optical image capture structure of the present invention to be operated in the first and second axial directions further includes a driving circuit 150, a first axial accelerometer 161, a second axial accelerometer 162, and an operation unit 200.

When a vibration occurs in the first axial direction, the first axial accelerometer 161 measures and calculates a transient acceleration of the vibration in the first axial direction, and records the action time of the transient acceleration in the first axial direction, and transfers the calculated transient acceleration and the action time of the vibration in the first axial direction to the operation unit 200.

The operation unit 200 receives the transient acceleration and the action time outputted by the first axial accelerometer 161, and then obtains a transient speed and a moving distance of the movement in the first axial direction by way of calculation, and the operation unit 200 controls to output a first axial control compensation signal corresponding to the vibration in the first axial direction to the driving circuit 150.

The driving circuit 150 receives the first axial control compensation signal outputted from the operation unit 200, and provides a first axial driving voltage for manipulating the first axial actuator 151 to move along the first axial direction, which then drives the photosensitive element 140 connected with the first axial actuator 151 to move along the first axial direction.

Likewise, the second axial accelerometer 162 is connected with the operation unit 200, the second axial actuator 152 is connected with the driving circuit 150, and the second axial actuator 152 is manipulated by the driving circuit 150. When a vibration occurs in the second axial direction, the second axial accelerometer 162 measures and calculates a transient acceleration of the vibration in the second axial direction, and records an action time of the transient acceleration in the second axial direction, and transfers the calculated transient acceleration and the action time of the vibration in the second axial direction to the operation unit 200. The driving circuit 150 receives a second axial control compensation signal outputted from the operation unit 200, and provides a second axial driving voltage for manipulating the second axial actuator 152 to move along the second axial direction, which then drives the photosensitive element 140 connected with the second axial actuator 152 to move along the second axial direction.

Through the effect of the above system, the photosensitive element 140 can be moved in a two-dimensional plane space through the first and second axial actuators 151 and 152, so as to instantly make a response and compensate the encountered vibration, thereby solving the problem of the fuzzy image caused by the vibration.

Then, referring to FIGS. 1 and 2B, FIG. 2B is a system schematic view of the optical image capture structure of the present invention to be operated in the third axial direction. The system for the optical image capture structure of the present invention to be operated in the third axial direction further includes a driving circuit 150, a third axial accelerometer 163, and an operation unit 200.

As for the third axial accelerometer 163, the operating manner, the signal transmission, and the connection relationship are the same as those of the first and second axial accelerometer 161 and 162. Moreover, the third axial direction is also an optical axis direction for the optical image capturing process, and thus the vibration in the third direction will affect the focusing function of the optical image capturing process. Since the third axial actuator 153 is controlled and compensated along the third axial direction, the system for the operation in the third axial direction can achieve both digital image stabilization and focusing functions.

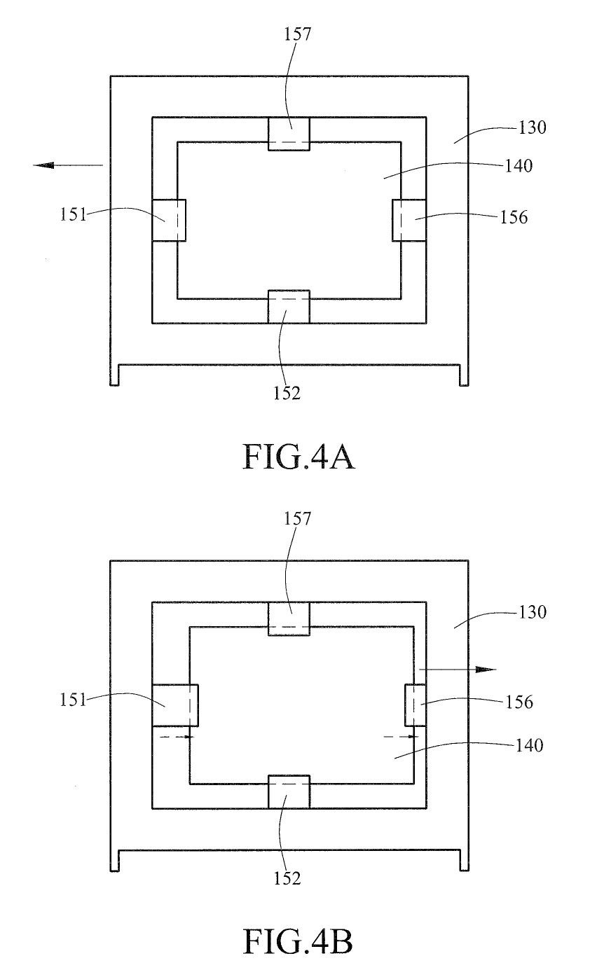

FIGS. 3A and 3B are schematic views of the operations according to a first embodiment of the present invention. In the first embodiment of the present invention, the first axial actuator 151 and the second axial actuator 152 are made of a piezoelectric material. Once an electric field (voltage) is applied, in order to resist the environment change, the piezoelectric material extends along the electric field direction, which is completed in an extremely short time period. The piezoelectric material is generally a piezoelectric ceramic, which takes ceramics (e.g., BaTiO₃ and PZT) as the piezoelectric material. Other piezoelectric material includes single crystals, such as quartz, tourmaline, rochelle salt, tantalate, and niobate, or films, such as ZnO.

When a vibration occurs to the frame 130 and the photosensitive element 140 in one direction, indicated by the arrow in FIG. 3A, the transient acceleration value and the action time value of the vibration in the first and second axial directions are transferred by the first and second axial accelerometer 161, 162 to the operation unit 200 to obtain the transient speed and the moving distance. The operation unit 200 controls to output the first and second axial control compensation signals corresponding to the vibration in the first and second axial directions to the driving circuit 150. The driving circuit 150 provides a first axial driving voltage and a second axial driving voltage (electric field) to the first and second axial actuators 151, 152 respectively, and thereby extending the first and second axial actuators 151 and 152 made of the piezoelectric material along the dotted-line arrow in the first and second axial directions. Therefore, the photosensitive element 140 connected with the first and second actuators 151 and 152 moves along the solid-line arrow in FIG. 3B, so as to compensate the image offset and shake caused by the vibration in the first and second axial directions.

Likewise, the third axial actuator 153 is also made of a piezoelectric material. If a vibration further contains a movement in the third axial direction, besides the movement in the first and second axial directions, the above-mentioned process is also applied in the third axial direction for compensating the image offset and shake caused by the vibration in the third axial direction.

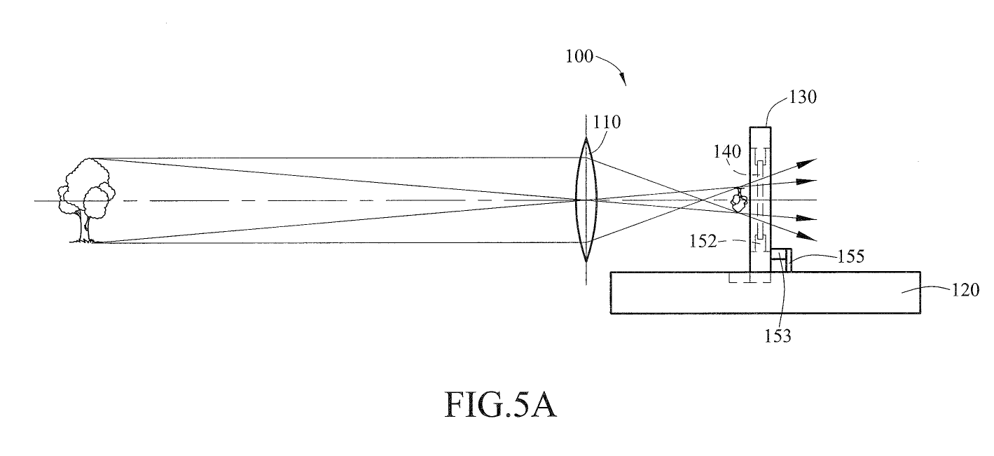

FIGS. 4A and 4B are schematic views of the operations according to a second embodiment of the present invention. The difference between the first embodiment and the second embodiment of the present invention lies in that, the second embodiment has two corresponding first axial actuators 151 and 156 and two corresponding second axial actuators 152 and 157, which are also made of a piezoelectric material.

Taking the first axial direction as an example, first of all, the driving circuit 150 applies the first axial driving voltage (electric field), as indicated by the direction of the arrow shown in FIG. 4A, to the first axial actuator 156 on the right side and makes the first axial actuator 156 to be extended, and thus, the first axial actuator 156 and the first axial actuator 151 on the left side are embedded into two opposite side edges of the photosensitive element 140. When a vibration occurs to the frame 130 and the photosensitive element 140 in the first axial direction, for example, indicated by the direction of the arrow shown in FIG. 4A, as that mentioned in the first embodiment, a first axial control compensation signal is outputted by the first axial accelerometer 161 and the operation unit 200 to the driving circuit 150. The driving circuit 150 applies a first axial driving voltage (electric field) in the direction, indicated by the dotted-line arrow shown in FIG. 4B, to the first axial actuator 151 on the left side, so as to extend the first axial actuator 151 on the left side, and correspondingly removes the electric field applied on the first axial actuator 156 on the right side and thereby shortening the first axial actuator 156, such that the photosensitive element 140 connected with the first axial actuators 151 and 156 moves in the direction indicated by the solid-line arrow shown in FIG. 4B, for compensating the image offset and shake caused by the vibration in the first axial direction. Likewise, the above-mentioned digital image stabilization (DIS) function in the first axial direction, which is taken as an example, also can be implemented in the control operation of the second axial actuators 152 and 157. The control operation of the third axial actuator 153 is the same as that mentioned in the first embodiment.

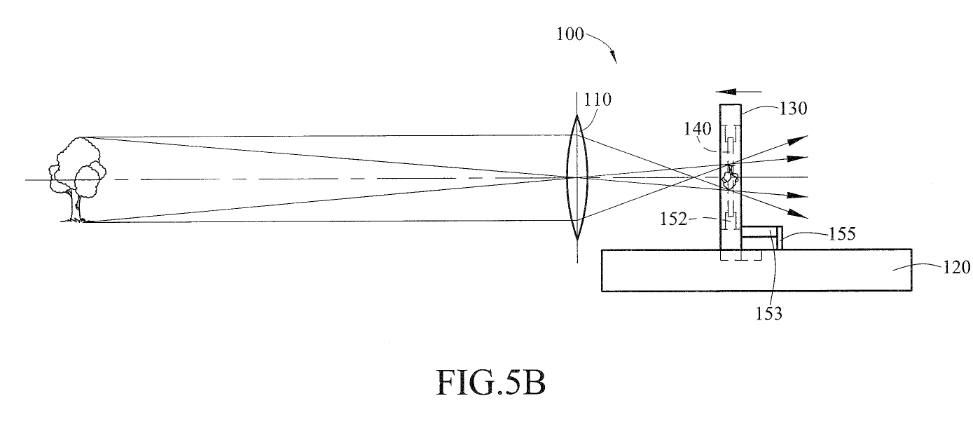

Moreover, referring to FIGS. 2B, 5A, and 5B, FIGS. 5A and 5B are schematic views of the focusing function operations of the optical image capture structure of the present invention. When an object is imaged through the lens assembly 110, due to the vibration of the hand or foot movement of the user, the image is formed in front of the photosensitive element 140, thus the image received by the photosensitive element is fuzzy due to the defocusing, as shown in FIG. 5A.

The optical image capture structure 100 provided by the present invention can utilize the system for operations in the third axial direction for controlling and compensation in the third axial direction, thus being focused. As shown in FIG. 5B, the third axial direction is the optical axis direction of the optical image capturing process, and since the system for operations in the third axial direction controls and compensates the third axial actuator 153 in the third axial direction, the third axial actuator 153 extends along the direction indicated by the arrow, and the frame 130 and the photosensitive element 140 also move along the third axial direction to the position shown in FIG. 5B, and thus, the image is formed on the photosensitive element 140, thereby achieving a focusing effect.

Therefore, as described above, the effect of the present invention lies in that, the provided optical image capture structure is designed into one architecture with both the digital image stabilization (DIS) function and the simple focusing functions. Moreover, three axial actuators that are perpendicular to each other are utilized to compensate the vibrations in all directions in the space, and a technique for driving a piezoelectric material is also utilized to achieve an instant and complete digital image stabilization (DIS) effect. Moreover, the piezoelectric material in the third axial direction is driven at the same time for achieving both the digital image stabilization (DIS) and focusing functions.

Therefore, the present invention can effectively enhance the image-shooting quality and image-shooting function of a common simple and chic optical image capture device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical image capture structure, for capturing an optical image focused and imaged through a lens, the optical image capture structure comprising:
a substrate;
a frame, moving on the substrate relatively;
a photosensitive element, mounted in the frame for capturing the optical image;
a first axial actuator, connected between the frame and the photosensitive element for moving the photosensitive element in a first direction;
a second axial actuator, connected between the frame and the photosensitive element for moving the photosensitive element in a second direction; and
a third axial actuator, connected between the frame and the substrate for moving the photosensitive element in a third axial direction.

2. The optical image capture structure as claimed in claim 1, wherein the first axial direction, the second axial direction and the third axial direction are vertical to each other.

3. The optical image capture structure as claimed in claim 1, wherein the substrate has a chute and a fixing member, and the frame has an embedded portion for being embedded into the substrate thereby moving the frame in the chute in the third axial direction, and the fixing member is used for fixing the third axial actuator.

4. The optical image capture structure as claimed in claim 1, wherein the photosensitive element is a charge-coupled device (CCD).

5. The optical image capture structure as claimed in claim 1, wherein the photosensitive element is a complementary metal-oxide semiconductor (CMOS).

6. The optical image capture structure as claimed in claim 1, further comprising a lens assembly parallel to the photosensitive element and having a distance therewith, thereby imaging the optical image on the photosensitive element.

7. The optical image capture structure as claimed in claim 6, wherein the lens assembly has at least a convex lens.

8. The optical image capture structure as claimed in claim 1, further comprising a driving circuit for transferring driven voltage in the first, the second and the third axial directions to the first, the second and the third axial actuators respectively, thereby moving the first, the second and the third axial actuators in each corresponding axial direction.

9. The optical image capture structure as claimed in claim 8, further comprising:
a first axial accelerometer, for calculating a transient acceleration value and an action time value produced by the optical image capture structure in the first axial direction;
a second axial accelerometer, for calculating a transient acceleration value and an action time value produced by the optical image capture structure in the second axial direction;
a third axial accelerometer, for calculating a transient acceleration value and an action time value produced by the optical image capture structure in the third axial direction; and
an operation unit, for receiving the transient acceleration values and action time values of the first, the second, and the third axial accelerometer, and after a calculation process, outputting a first, a second and a third axial control stabilization signals to the driving circuit for respectively controlling the first, second, and third axial actuator.

10. The optical image capture structure as claimed in claim 1, wherein the first axial actuator, the second axial actuator and the third axial actuator are made of a piezoelectric material.
